(19) United States
(12) Patent Application Publication
(10) Pub. No.: US 2013/0163519 A1
(43) Pub. Date: Jun. 27, 2013

(54) REDUCED CELL ID REASSIGNMENTS IN MULTI-BAND LOCAL AREA

(71) Applicants: Cassio Ribeiro, Espoo (FI); Klaus Doppler, Berkley, CA (US); Olav Tirkkonen, Helsinki (FI)

(72) Inventors: Cassio Ribeiro, Espoo (FI); Klaus Doppler, Berkley, CA (US); Olav Tirkkonen, Helsinki (FI)

(73) Assignee: NOKIA CORPORATION, Espoo (FI)

(21) Appl. No.: 13/805,096

(22) PCT Filed: Jun. 26, 2011
(86) PCT No.: PCT/IB11/01482

§ 371 Date: Mar. 11, 2013

(51) Int. Cl. H04W 76/02

(52) U.S. Cl. CPC H04W 76/021
USPC 370/328

(57) ABSTRACT

A method, apparatus, and computer program is provided which allows an access point that is operating in multiple bands to be able to have a conflict-free cell identity when hopping to different bands. A first message is received, at an access point, indicating that a reassignment of cell identities has been triggered in a first band. A second message is transmitted, at the access point, indicating if the access point will participate in the reassignment.

### CROSS-REFERENCE TO RELATED APPLICATIONS

This application claims priority of U.S. Provisional Patent Application Ser. No. 61/358,706, filed on Jun. 25, 2010. The subject matter of the earlier filed application is hereby incorporated by reference.

### BACKGROUND

1. Field

Some embodiments of the invention relate generally to local area radio systems which complement cellular wide area systems (such as Global System for Mobile Communications (GSM), Universal Mobile Telecommunications System (UMTS), High Speed Packet Access (HSPA), and Long Term Evolution (LTE)), and particularly to LTE-Advanced local area radio systems.

2. Description of the Related Art

A cellular system is a radio system made up of a number of cells, each served by at least one access point (such as an evolved Node B (eNB)). When joined together, these cells can provide radio coverage over a wide geographic area. A cellular system can have a wide area system component and a local area system component, where the local area system can complement the wide area system. Unlike a wide area cellular system, a local area system can utilize a license-exempt spectrum (or white spaces) to take advantage of additional available bandwidth. In addition, the local area system can offer a device-to-device operation mode to establish an ad-hoc network, which is a decentralized wireless network that does not require an access point to operate, or in an alternate scenario, the wide area system can offer a device-to-device operation mode, where the wide area system includes a local area connection.

In any cellular system, resources need to be distributed among the access points. An example of a resource that needs to be distributed is a physical cell identity (ID), also identified as a cell ID, which identifies the cell and distinguishes it from the other cells in the cellular system. A cell ID can be a unique combination of one orthogonal sequence and one pseudo-random sequence. Due to the uncoordinated nature of local area system deployments, a self-optimization mechanism can be required in order to distribute resources, such as cell IDs, among the access points efficiently. While random distribution of cell IDs is possible, due to the large number of visible neighbors in local area system deployments, decentralized algorithms which take advantage of communication between access points can be used in order to limit the number of cell IDs to a reasonable number. Furthermore, each time a new access point is added to the network, a distribution of cell IDs must be evaluated, which can result in a reassignment of cell IDs in the entire network.

Given that uncoordinated deployments are likely to be used, that each access point in a local area system can operate in licensed and unlicensed bands, and that several carriers can be available for operation in a given frequency band, this means that access points may operate simultaneously in multiple bands or carriers, or else they may hop to different carriers according to an observed load and interference level. This hopping can be triggered, for example, if a load in a cell varies, requiring more or less resources for operation. The access point can then hop to a different band where it has access to extra capacity. As another example, when operating using unlicensed bands, a network is subject to interference from a non-cooperating node in the vicinity, such as a legacy 802.11 access point. If the access point notices this interference situation, the access point can hop to a different channel or band with a smaller amount of interference.

When an access point hops to a new band where it has not operated before, it is similarly considered as a new cell, and the access point starts a cell ID assignment procedure, where the access point acquires a cell ID to use in the network. For example, if an assignment of IDs is based on measurements in the 2-hop neighborhood of the access point, this means that the cell ID assignment procedure involves measurements of the access points and the attached user equipments, and signaling exchanges between the access points in the 2-hop neighborhood. An initiation of a cell ID procedure could also mean that cell IDs will have to be changed all around the network, which implies at least one cell ID reassignment per access point. A cell ID reassignment can include changes to at least some parameters used by the access point, such as synchronization sequence and reference signal. These parameters may have to be signaled to a user equipment that is communicating with the access point in order to prevent the user equipment from losing its connection to the access point. If a user equipment is in a power save mode with a discontinuous reception cycle enabled, it can take up to several seconds until all the user equipments are notified. The normal network operation can be interrupted for several seconds until the network recovers from a cell ID conflict. As a consequence, such cell ID reassignments should be very infrequent and avoided if possible.

In principle, the same procedure applies if the access point is returning to a channel where it has operated recently, since the topology of the network may have changed during the access point's absence. For example, if another access point joined the channel while the first access point was absent, the cell IDs are likely to have been reassigned, and the previous ID cannot be guaranteed to be valid anymore. In other words, an access point moving between bands or channels implies the same procedure as a new cell, i.e., extra measurements and reassignments. These extra measurements and reassignments can limit the possibilities for band changes, and consequently can limit the capabilities of the network to adapt to varying load and interference situations.

### SUMMARY

According to an embodiment of the invention, a method includes receiving, at an access point, a first message indicating that a reassignment of cell identities has been triggered in a first band. The method further includes transmitting, at the access point, a second message indicating if the access point will participate in the reassignment.

According to another embodiment, an apparatus includes a processor, and a memory including computer program code. The memory and the computer program code are configured to, with the processor, cause the apparatus to receive a first message indicating that a reassignment of cell identities has been triggered in a first band, and transmit a second message indicating if the apparatus will participate in the reassignment.

According to another embodiment, a computer-readable medium has a computer program stored thereon that, when executed by a processor, causes the processor to implement a method. The method includes receiving, at an access point, a first message indicating that a reassignment of cell identities has been triggered in a first band. The method further includes transmitting, at the access point, a second message indicating if the access point will participate in the reassignment.

According to another embodiment, an apparatus includes receiving means for receiving a first message indicating that a reassignment of cell identities has been triggered in a first band. The apparatus further includes transmitting means for transmitting a second message indicating if the access point will participate in the reassignment.

According to another embodiment, a method includes receiving a first message, at a support node, indicating that a new access point has been activated in a first band. The method further includes determining, at the support node, whether one or more access points are operating, or are configured to operate, in the first band. The method further includes transmitting a second message, at the support node, to the one or more access points, indicating that a reassignment of cell identities has been triggered in the first band.

According to another embodiment, an apparatus includes a processor, and a memory including computer program code. The memory and the computer program code are configured to, with the processor, cause the apparatus to receive a first message indicating that a new access point has been activated in a first band, determine whether one or more access points are operating, or are configured to operate, in the first band, and transmit a second message, at the support node, to the one or more access points, indicating that a reassignment of cell identities has been

### BRIEF DESCRIPTION OF THE DRAWINGS

Further embodiments, details, advantages, and modifications of the present invention will become apparent from the following detailed description of the preferred embodiments, which is to be taken in conjunction with the accompanying drawings, wherein:

FIG. 1 illustrates a multi-band operation in a communication system according to an embodiment of the invention.

FIG. 2 illustrates a cell ID assignment procedure according to an embodiment of the invention.

FIG. 3 illustrates a cell ID assignment procedure according to another embodiment of the invention.

FIG. 4 illustrates a method in accordance with an embodiment of the invention.

FIG. 5 illustrates an example embodiment of an apparatus.

FIG. 6 illustrates a method in accordance with another embodiment of the invention.

FIG. 7 illustrates another example embodiment of an apparatus.

### DETAILED DESCRIPTION

It will be readily understood that the components of the present invention, as generally described and illustrated in the figures herein, may be arranged and designed in a wide variety of different configurations. Thus, the following detailed description of the embodiments of a method, apparatus, system, and computer-readable medium as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of the phrases “certain embodiments,” “some embodiments,” or other similar language, throughout this specification refers to the fact that a particular feature, structure, or characteristic described in connection with the embodiment may be included in at least one embodiment of the present invention. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more embodiments.

According to an embodiment of the invention, a method, apparatus, and computer-readable medium is provided which allows an access point that is operating in multiple bands to be able to have a conflict-free cell ID when hopping to different bands. The mechanism can reduce the need for cell ID reassignments and corresponding measurements, especially for access points that do not actively require changes in the network topology.

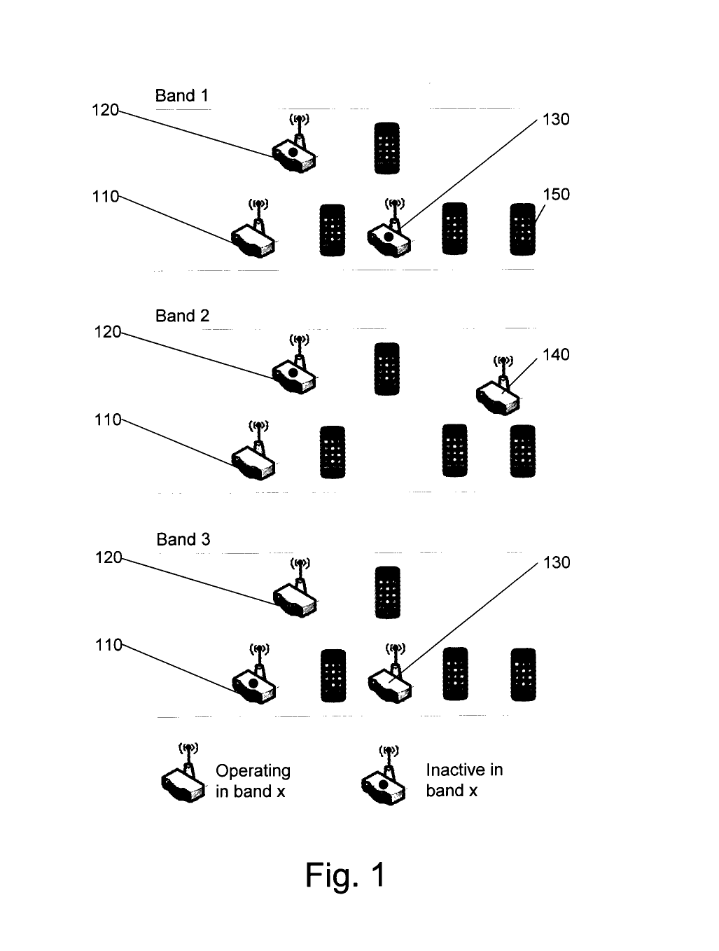

FIG. 1 illustrates a multi-band operation in a communication system according to an embodiment of the invention. In the illustrated embodiment, the communication system is a local area communication system that contains access points capable of operating in multiple bands or carriers. However, one of ordinary skill in the art would appreciate that in other embodiments, the communication system can be a different type of communication system.

In the illustrated embodiment, FIG. 1 illustrates a communication system which includes three bands, band 1, band 2, and band 3, and includes access points 110, 120, 130, and 140. The communication system also includes multiple user equipments in each of bands 1, 2, and 3, represented by user equipment 150. As one of ordinary skill in the art would readily appreciate, FIG. 1 is merely an illustrative embodiment of the invention, and a communication system can include any number of bands, access points, and user equipments, and still be within the scope of the invention. Furthermore, the configuration illustrated in FIG. 1 is merely an illustrative configuration according to an embodiment of the invention, and the access points and user equipments within each band can be configured in any manner and still be within the scope of the invention.

According to the embodiment, an access point is capable of operating on multiple bands, and an access point can be active in some bands, but inactive in other bands.

In the illustrated embodiment, access point 110 is capable of operating in bands 1, 2, and 3, but is only active in bands 1 and 2, and is inactive in band 3. Similar to access point 110, access point 120 is capable of operating in bands 1, 2, and 3. However, in contrast to access point 110, access point 120 is inactive in bands 1 and 2, and active in band 3. In the illustrated embodiment, access point 130 is only capable of operating in bands 1 and 3, and is not capable of operating in band 2. Access point 130 is inactive in band 1, and is active in band 3. Access point 140 is only capable of operating in band 2, and is active in band 2. According to the embodiment, at least some of the access points operating in the different bands can be connected to a common sub-net, and cell IDs can be distributed independently for each band. Thus, an access point operating in different bands can have different cell IDs.

A local area communication system can also include a network element identified as a support node (not shown in FIG. 1). A support node can provide support functions for the access points connected to its sub-net. A support node can also provide limited support to all local area communication systems in a certain area, such as a particular country. One of the support functions that a support node can provide is assigning cell IDs.

According to an embodiment of the invention, a support node can keep a list of access points that operate (or have operated) in different bands. Using this list, the support node can notify an access point if a reassignment of cell IDs is occurring in a band where the access point has been operating recently, such as during the last 24 hours, during the last week, or during the last year. The access point can then participate in the measurements and signaling exchange that is part of a cell ID reassignment in the band. This participation can guarantee that the access point will have a valid cell ID if the access point hops back to that band. In an alternative embodiment, the access point can decide not to participate in the measurements and signaling exchange of the cell ID reassignment. For example, the access point can determine that it does not intend to utilize the other band in the near future, or the access point may be involved in an operation that it cannot interrupt when it receives the notification. In either embodiment, the access point can reply with a message indicating whether or not it will participate in the cell ID reassignment in the band. According to an embodiment, if the access point does not transmit a message, it is assumed that the access point will not participate in the cell ID reassignment, and the access point's previous cell ID will not be considered in the reassignment procedure. Moreover, according to the embodiment, the access point will not receive further notifications regarding the band.

The embodiment described above can be characterized as a “centralized” procedure for notifying access points of cell ID reassignment, as a centralized network element, such as a support node, is capable of keeping a list of access points that operate in different bands, and is capable of transmitting notification messages to access points when a reassignment of cell IDs occurs. However, in an alternative embodiment of the invention, characterized as a “decentralized” procedure for notifying access points of cell ID reassignment, access points can relay notification messages to each other without the need for a centralized network element. In this embodiment, there can be an established interface between cells, such as an X2 interface, which an access point can use to transmit a notification message to another access point, notifying the access point of a cell ID reassignment. This interface can remain established even if an access point hops away from the band. As an alternative, according to the embodiment, an access point can utilize a user equipment to relay a notification message to another access point. Thus, according to the embodiment, a neighboring access point can alert an access point (which operates on another band) that there is a cell ID reassignment occurring in the band. The access point is then able to participate in the reassignment, in the scenario that the access point is interested in participating in the reassignment. The centralized procedure and decentralized procedure will be discussed in more detail.

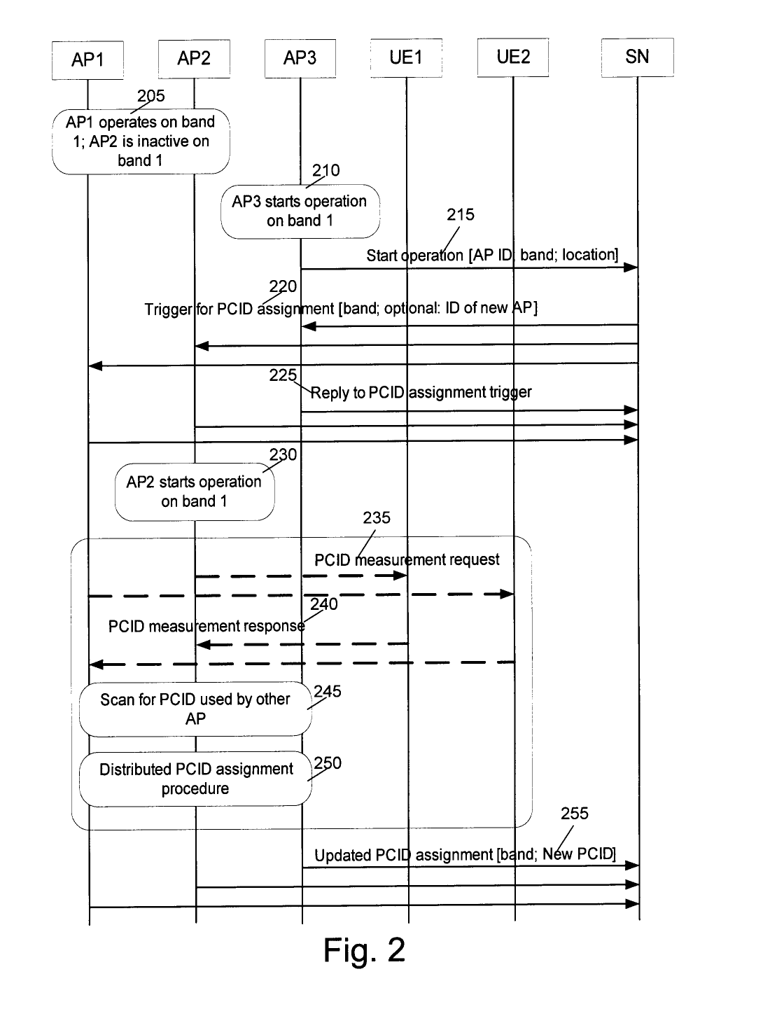

FIG. 2 illustrates a cell ID assignment procedure according to an embodiment of the invention. More specifically, FIG. 2 illustrates an example embodiment of the invention utilizing a centralized procedure for assigning a cell ID. The illustrated embodiment includes three access points (identified in FIGS. 2 as AP1, AP2, and AP3), two user equipments (identified in FIG. 2 as UE1 and UE2), and a support node (identified in FIG. 2 as SN). According to the embodiment, access points AP1, AP2, and AP3 can operate on multiple bands, where each access point can be active on some bands, but inactive on other bands. Also according to the embodiment, support node SN can assist with cell ID reassignment when a new access point joins a band, as will be described in more detail.

At step 205, access point AP1 operates on band 1, and access point AP2 is inactive on band 1. At step 210, access point AP3 starts operating on band 1. When access point AP3 starts operating on band 1, at step 215, access point AP3 transmits a notification message to support node SN, notifying support node SN that it has started, or intends, to operate on band 1. According to an embodiment of the invention, the notification message can be a global unique ID of access point AP3, location information of access point AP3, and a band that access point AP3 wants to operate in (in this case, band 1). According to the embodiment, the location information can include information such as geographical coordinates, a physical address, or radio environment information. Examples of radio environment information include a list of received cellular and local area radios, where the list can optionally include signal strength information. The location information can also include the global unique ID of access points that have been identified by access point AP3 in all possible operation bands of access point AP3. This information can be gathered by access point AP3 over time in measurements of the access point and its connected user equipment. In an embodiment where the location information is already known by the support node, this information can be omitted.

At step 220, based on the location information of the notification message received at step 215, support node SN identifies that access points AP1 and AP2 are capable of operating on the same band that access point AP3 has started to operate in (i.e., band 1), and that access points AP1 and AP2 are in the vicinity of access point AP3. In an embodiment, access points AP1 and AP2 can be in the vicinity of access point AP3 if the access points are in the same building as access point AP3. In another embodiment, access points AP1 and AP2 can be in the vicinity of access point AP3 if the access points are in a two-hop neighborhood of access point AP3. Support node SN then transmits a notification message to access points AP1 and AP2, notifying each access point that a new access point has started to operate in band 1. According to the embodiment, the notification message can include the band that access point AP3 has started to operate in (i.e., band 1). In an alternate embodiment, the notification message can also include the global unique ID of access point AP3, and the physical cell ID (PCID) that access point AP3 will use initially. Furthermore, at step 220, support node SN also triggers a PCID assignment procedure. According to the embodiment, the PCID assignment procedure includes transmitting a message to each of the access points AP1, AP2, and AP3.

At step 225, each of the access points AP1, AP2, and AP3 transmit a reply message indicating whether or not the access point will join the PCID assignment procedure, and the measurements involved in the PCID assignment procedure. In the illustrated embodiment, access point AP2 is inactive in band 1. Thus, according to the embodiment, access point AP2 is given an opportunity to participate in the PCID assignment procedure, even though access point AP2 is not operating in band 1 at the time the PCID assignment procedure is triggered.

At step 230, access point AP2, which was previously inactive in band 1, begins to operate on band 1. According to an embodiment of the invention, support node SN can know that access point AP2 was previously inactive in band 1, and support node SN can first ask access point AP2 if it wants to participate in the PCID assignment procedure, and can give access point AP2 some time to begin operation in band 1 before notifying the other access points.

At steps 235, 240, 245, and 250, a PCID assignment procedure is initiated. The PCID assignment procedure can be one of several types of PCID assignment procedures. For example, the PCID assignment procedure can include transmitting requests for information to neighboring access points, requesting information related to a PCID of neighboring access points, and receiving PCID information coupled with a parameter indicating a relevance of the received PCID information. For example, the relevance parameter can be a visibility measure. The visibility measure can be, in accordance with an embodiment of the invention, an indication of a number of measurement reports that have been received for a particular access point associated with a particular PCID. In accordance with another embodiment of the invention, the visibility measure can be a number of handovers that have been made to the particular access point. As another example, the PCID assignment procedure can include broadcasting that an access point is in a PCID search phase, and receiving PCIDs of all neighboring access points from one or more supporting user equipments. In another example, the PCID assignment procedure can include obtaining PCID information of an access point that is in the same subnet (or in some circumstances over a different subnet, although special procedures may be required) over an inter-access point interface, such as an X2 interface. The PCID assignment procedure can also include acquiring a temporary PCID, by a new access point, for a duration until a permanent PCID is acquired, so that other access points can identify that the access point is a new access point. The PCID assignment procedure can also include decoding a received system information block received by a new access point in order to identify whether a PCID already belongs to another access point. For example, an access point or a user equipment can send a system information block which contains parameters relating to another access point. The system information block can include a PCID of the another access point. The PCID assignment procedure can also include communication between two or more access points facilitated by a support node.

In the illustrated embodiment, at step 235, access point AP1 transmits a PCID measurement request to user equipment UE2, and access point AP2 transmits a PCID measurement request to user equipment UE1. At step 240, user equipment UE2 transmits a PCID measurement request response to access point AP1, and user equipment UE1 transmits a PCID measurement request response to access point AP2. Each PCID measurement request response can include one or more PCIDs of neighboring access points. At step 245, access points AP1, AP2, and AP3 scan for PCIDs used by neighboring access points. As previously described, scanning for a PCID can include transmitting requests for information to neighboring access points and receiving PCID information coupled with a parameter indicating a relevance of the received PCID information, and obtaining PCID information of an access point that is in the same subnet (or in some circumstances over a different subnet) over an inter-access point interface. For example, the relevance parameter can be a visibility measure. The visibility measure can be, in accordance with an embodiment of the invention, an indication of a number of measurement reports that have been received for a particular access point associated with a particular PCID. In accordance with another embodiment of the invention, the visibility measure can be a number of handovers that have been made to the particular access point. At step 250, a distributed PCID assignment procedure is executed. According to the embodiment, the distributed PCID assignment procedure uses the information obtained by the PCID measurement requests in steps 235 and 240, and the information obtained by the scanning in steps 245 and 250 to obtain a unique PCID for access points AP1, AP2, and AP3.

At step 255, access points AP1, AP2, and AP3 each transmit a message to support node SN updating its assigned PCID. According to the embodiment, the message includes the band (i.e., band 1), and a new PCID for each access point.

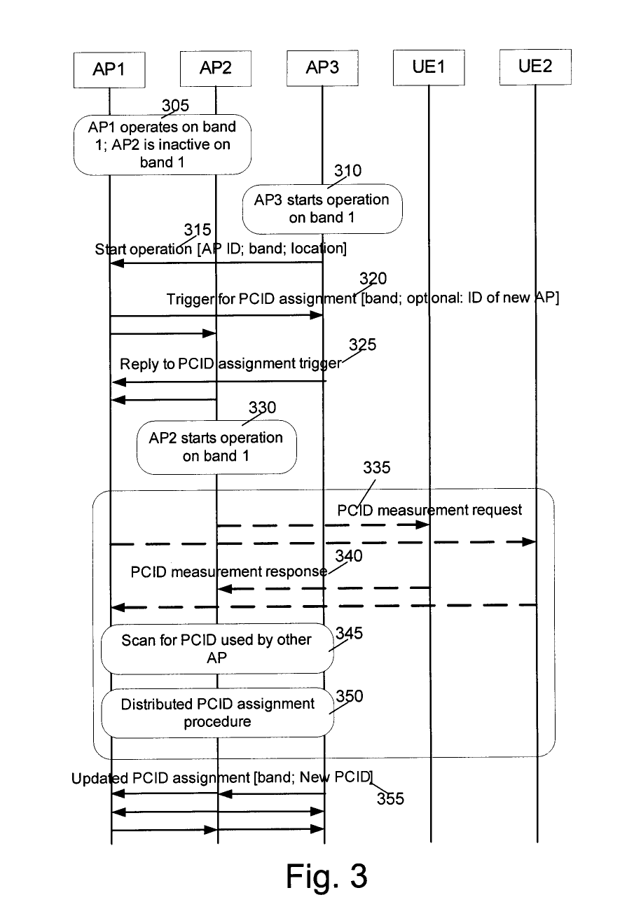

FIG. 3 illustrates a cell ID assignment procedure according to another embodiment of the invention. More specifically, FIG. 3 illustrates an example embodiment of the invention utilizing a decentralized procedure for assigning a cell ID. Similar to the embodiment illustrated in FIG. 2, the illustrated embodiment includes three access points (identified in FIGS. 3 as AP1, AP2, and AP3), and two user equipments (identified in FIG. 3 as UE1 and UE2). In contrast to the embodiment illustrated in FIG. 2, the illustrated embodiment does not include a support node. According to the embodiment, access points AP1, AP2, and AP3 are each capable of operating on multiple bands, where each access point can be active on some bands, but inactive on other bands. Also according to the embodiment, access points coordinate cell ID reassignment amongst themselves when a new access point joins a band, without the need for a support node, as will be described in more detail. Instead of a support node, there is a common interface (not shown) between access points AP1 and AP2, and access point AP3 can join the common interface or establish a new interface with access point AP1.

At step 305, access point AP1 operates on band 1, and access point AP2 is inactive on band 1. At step 310, access point AP3 starts operating on band 1. At step 315, access point AP3 transmits a notification message to access point AP1, notifying access point AP1 that a new access point has started to operate in band 1. According to an embodiment of the invention, the notification message can include a global unique ID of access point AP3, location information of access point AP3, and a band that access point AP3 wants to operate in (in this case, band 1). According to the embodiment, the location information can include information such as geographical coordinates, a physical address, or radio environment information. Examples of radio environment information include a list of received cellular and local area radios, where the list can optionally include signal strength information. The location information can also include the global unique ID of access points that have been identified by access point AP3 in all possible operation bands of access point AP3. This information can be gathered by access point AP3 over time in measurements of the access point and its connected user equipment. In an alternative embodiment, access point AP3 can transmit a broadcast channel or broadcast beacon with information on its intended operation.

At step 320, based on the location information of the notification message (or beacon) received at step 315, access point AP1 identifies that access point AP3 has started to operate in band 1. Also at step 320, access point AP1 identifies that access point AP2 can operate in the same band as access point AP3, and that access point AP2 is in a vicinity of access point AP3. Access point AP1 can identify that access point AP2 can operate in the area of access point AP3 either based on the location information of the notification message received at step 315, or based on independent measurements of AP1. Access point AP1 can identify that access point AP2 can operate in the same band as access point AP3 based on past operation of access point AP2 in the band observed by access point AP1 or by system information received from access point AP2, such as a broadcast channel or as a message received from access point AP2 via an inter-access point interface (such as an X2 interface) between access point AP1 and access point AP2, or as a message received from support node SN containing the capabilities of access point AP2. Furthermore, also at step 320, access point AP1 transmits a notification message to access point AP2, notifying access point AP2 that a new access point has started to operate in band 1. According to the embodiment, the notification message can include the band that access point AP3 has started to operate in (i.e., band 1), and an indication that access points AP1 and AP2 are in the vicinity of access point AP3. In an embodiment, access points AP1 and AP2 can be in the vicinity of access point AP3 if the access points are in the same building as access point AP3. In another embodiment, access points AP1 and AP2 can be in the vicinity of access point AP3 if the access points are in a two-hop neighborhood of access point AP3. In an alternate embodiment, the notification message can also include the global unique ID of access point AP3 and the PCID that access point AP3 will use initially. In an embodiment, also at step 320, access point AP1 may trigger a physical PCID assignment procedure. According to the embodiment, the PCID assignment procedure includes transmitting a message to access points AP2 and AP3.

At step 325, access points AP2 and AP3 transmit a reply message indicating whether or not the access point will join the PCID assignment procedure, and the measurements involved in the PCID assignment procedure. In the illustrated embodiment, access point AP2 is inactive in band 1. Thus, according to the embodiment, access point AP2 is given an opportunity to participate in the PCID assignment procedure, even though access point AP2 is not operating in band 1 at the time the PCID assignment procedure is triggered.

At step 330, access point AP2, which was previously inactive in band 1, begins to operate on band 1. According to an embodiment of the invention, access point AP1 can know that access point AP2 was previously active in band 1, and access point AP1 can first ask access point AP2 if it wants to participate in the PCID assignment procedure, and can give access point AP2 some time to begin operation in band 1 before notifying the other access points.

At steps 335, 340, 345, and 350, a PCID assignment procedure is initiated. As previously described with respect to the embodiment illustrated in FIG. 2, the PCID assignment procedure can be one of several types PCID assignment procedures. For example, the PCID assignment procedure can include transmitting requests for information to neighboring access points, requesting information related to a PCID of neighboring access points, and receiving PCID information coupled with a parameter indicating a relevance of the received PCID information. For example, the relevance parameter can be a visibility measure. The visibility measure can be, in accordance with an embodiment of the invention, an indication of a number of measurement reports that have been received for a particular access point associated with a particular PCID. In accordance with another embodiment of the invention, the visibility measure can be a number of handovers that have been made to the particular access point. As another example, the PCID assignment procedure can include broadcasting that an access point is an a PCID search phase, and receiving

PCIDs of all neighboring access points from one or more supporting user equipments. In another example, the PCID assignment procedure can include obtaining PCID information of an access point that is in the same subnet (or in some circumstances over a different subnet, although special procedures may be required) over an inter-access point interface, such as an X2 interface. The PCID assignment procedure can also include acquiring a temporary PCID, by a new access point, for a duration until a permanent PCID is acquired, so that other access points can identify that the access point is a new access point. The PCID assignment procedure can also include decoding a received system information block received by a new access point in order to identify whether a PCID already belongs to another access point. For example, an access point or a user equipment can send a system information block which contains parameters relating to another access point. The system information block can include a PCID of another access point.

In the illustrated embodiment, at step 335, access point AP1 transmits a PCID measurement request to user equipment UE2, and access point AP2 transmits a PCID measurement request to user equipment UE1. At step 340, user equipment UE2 transmits a PCID measurement request response to access point AP1, and user equipment UE1 transmits a PCID measurement request response to access point AP2. Each PCID measurement request response can include one or more PCIDs of neighboring access points. At step 345, access points AP1, AP2, and AP3 scan for PCIDs used by neighboring access points. As previously described, scanning for a PCID can include transmitting requests for information to neighboring access points and receiving PCID information coupled with a parameter indicating the relevance of the received PCID information, and obtaining PCID information of an access point that is in the same subnet (or in some circumstances over a different subnet) over an inter-access point interface. For example, the relevance parameter can be a visibility measure. The visibility measure can be, in accordance with an embodiment of the invention, an indication of a number of measurement reports that have been received for a particular access point associated with a particular PCID. In accordance with another embodiment of the invention, the visibility measure can be a number of handovers that have been made to the particular access point. At step 350, a distributed PCID assignment procedure is executed. According to the embodiment, the distributed PCID assignment procedure uses the information obtained by the PCID measurement requests in steps 335 and 340, and the information obtained by the scanning in steps 345 and 350 to obtain a unique PCID for access points AP1, AP2, and AP3.

At step 355, access points AP1, AP2, and AP3 each transmit a message to the other access points updating its assigned PCID. According to the embodiment, the message includes the band (i.e., band 1), and a PCID for each access point. In an example embodiment, the PCID for each access point can be a PCID currently in use for each access point. In an alternate embodiment of the invention, the message can also include a updated list of PCIDs used by access points in a neighborhood of a transmitting access point. According to an embodiment, the updated list of PCIDs can include a unique ID for each access point together with the PCID for each access point.

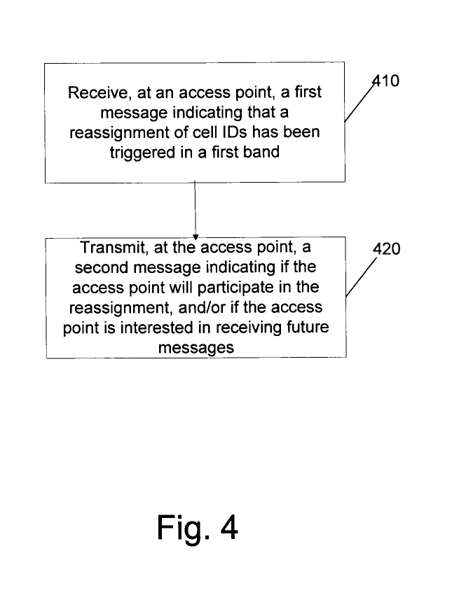

FIG. 4 illustrates a method in accordance with an embodiment of the invention. At 410, a first message is received, at an access point, indicating that a reassignment of cell IDs has been triggered in a first band. At 420, a second message is transmitted, at the access point, indicating if the access point will participate in the reassignment. In an alternate embodiment of the invention, the second message can also indicate if the access point is interested in receiving future messages.

According to an embodiment of the invention, the first message can be received from a support node. The method can also include transmitting a third message to the support node notifying the support node that the access point is interested in receiving further messages about cell identity reassignments in any bands where the access point was previously operating, when the access point changes bands. In another embodiment, when the access point has started, or intends, to operate in a first band, the method can include transmitting a fourth message, at the access point, indicating that the access point has started, or intends, to operate in a first band.

In an alternate embodiment, the first message can be received from another access point over a common interface. According to the embodiment, when the access point changes bands, a third message can be transmitted to other access points in a same neighborhood as the access point, notifying the other access points that the access point is interested in receiving further messages about cell identity reassignments in any bands where the access point was previously operating. In another embodiment, when the access point has started, or intends, to operate in a first band, a fourth message can be transmitted, at the access point, indicating that the access point has started, or intends, to operate in a first band. In another embodiment, a fifth message may be received, at the access point, from another access point indicating that the another access point has started, or intends, to operate in a first band.

The steps of a method or algorithm described in connection with the embodiments disclosed herein may be embodied directly in hardware, in a computer program executed by a processor, or in a combination of the two. A computer program may be embodied on a computer readable medium, such as a storage medium. For example, a computer program may reside in random access memory (RAM), flash memory, read-only memory (ROM), erasable programmable read-only memory (EPROM), electrically erasable programmable read-only memory (EEPROM), registers, hard disk, a removable disk, a compact disk read-only memory (CD-ROM), or any other form of storage medium known in the art. An exemplary storage medium may be coupled to the processor such that the processor can read information from, and write information to, the storage medium. In the alternative, the storage medium may be integral to the processor. The processor and the storage medium may reside in an application specific integrated circuit (ASIC). In the alternative, the processor and the storage medium may reside as discrete components.

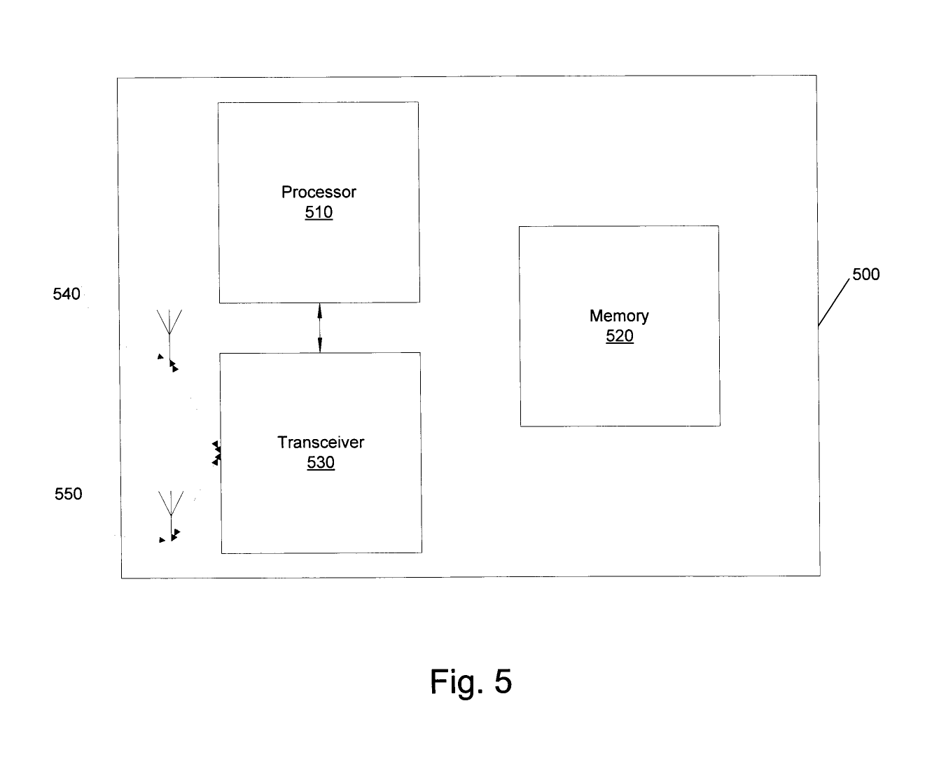

FIG. 5 illustrates a block diagram of an apparatus 500 according to one embodiment. Apparatus 500 can include a processor 510 and a memory 520. Processor 510 can read information from, and write information to, memory 520. Processor 510 can be a front end processor, a back end processor, a microprocessor, a digital signal processor, a processor with an accompanying digital signal processor, a special-purpose computer chip, a field-programmable gate array (FPGA), a controller, an ASIC, or a computer. Memory 520 can be RAM, flash memory, ROM, EPROM, EEPROM, registers, hard disk, a removable disk, a CD-ROM, or any other form of storage medium known in the art. Memory 520 can include computer program code. As one of ordinary skill in the art would readily appreciate, apparatus 500 can include any number of processors in alternative embodiments. Likewise, apparatus 500 can include any number of memories in alternative embodiments.

Apparatus 500 can also include a transceiver 530, which is configured to transmit and receive a message, and which is connected to processor 510. Apparatus 500 can also include antennas 540 and 550, where each antenna is configured to assist transceiver 530 in the transmitting and receiving of a message. While the illustrated embodiment in FIG. 5 depicts two antennas, one of ordinary skill in the art would readily appreciate that apparatus 500 can include any number of antennas in alternative embodiments. In an alternative embodiment, apparatus 500 can include a single antenna.

In an embodiment of the invention, processor 510 and memory 520 can cause apparatus 500 to receive a first message indicating that a reassignment of cell identities has been triggered in a first band. Processor 510 and memory 520 can also cause apparatus 500 to transmit a second message indicating if apparatus 500 will participate in the reassignment, and/or if apparatus 500 is interested in receiving future messages.

According to an embodiment, processor 510 and memory 520 can cause apparatus 500 to receive the first message from a support node. Processor 510 and memory 520 can also cause apparatus 500 to transmit a third message to the support node notifying the support node that apparatus 500 is interested in receiving further messages about cell identity reassignments in any bands where apparatus 500 was previously operating, when the access point changes bands. In another embodiment, when the apparatus 500 has started, or intends, to operate in a first band, processor 510 and memory 520 can also cause apparatus 500 to transmit a fourth message, indicating that the apparatus 500 has started, or intends, to operate in a first band.

In an alternate embodiment, processor 510 and memory 520 can cause apparatus 500 to receive the first message from an access point over a common interface. Processor 510 and memory 520 can also cause apparatus 500 to transmit a third message to other access points in a same neighborhood as apparatus 500 notifying the other access points that apparatus 500 is interested in receiving further messages about cell identity reassignments in any bands where apparatus 500 was previously operating, when the apparatus changes bands. In another embodiment, when the apparatus 500 has started, or intends, to operate in a first band, processor 510 and memory 520 can also cause apparatus 500 to transmit a fourth message, indicating that the apparatus 500 has started, or intends, to operate in a first band. In another embodiment, processor 510 and memory 520 can also cause apparatus 500 to receive a fifth message from another apparatus indicating that the another apparatus has started, or intends, to operate in a first band.

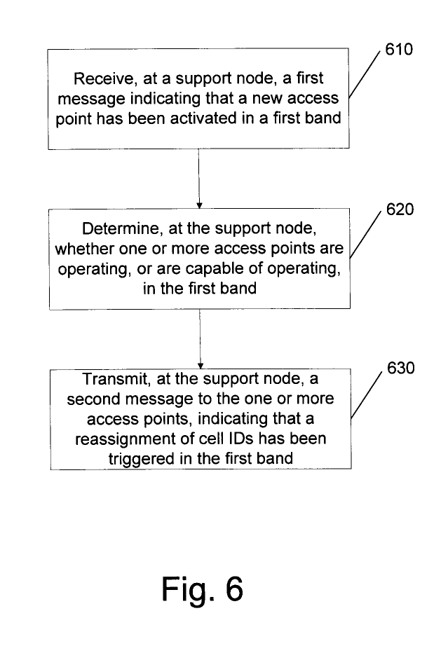

FIG. 6 illustrates a method in accordance with another embodiment of the invention. At 610, a first message is received, at a support node, indicating that a new access point has been activated in a first band. At 620, it is determined, at the support node, whether one or more access points are operating, or are capable of operating, in the first band. If it is determined that one or more access points are operating, or are capable of operating, in the first band, at 630, a second message is transmitted, at the support node, to the one or more access points, indicating that a reassignment of cell IDs has been triggered in the first band. According to an embodiment of the invention, the support node can include a database which includes a list of one or more access points that are operating, or are capable of operating, in the first band. According to the embodiment, the determination of whether one or more access points are operating, or are capable of operating, in the first band can include searching the database and identifying the one or more access points operating, or capable of operating, in the first band.

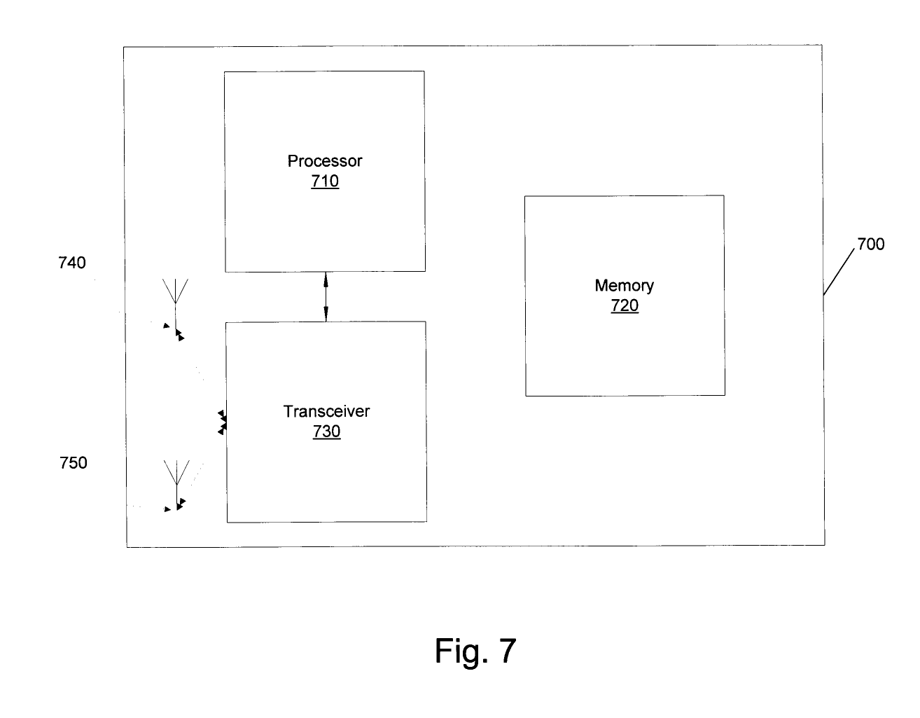

FIG. 7 illustrates another example embodiment of an apparatus. Apparatus 700 can include a processor 710 and a memory 720. Processor 710 can read information from, and write information to, memory 720. Processor 710 can be a front end processor, a back end processor, a microprocessor, a digital signal processor, a processor with an accompanying digital signal processor, a special-purpose computer chip, a FPGA, a controller, an ASIC, or a computer. Memory 720 can be RAM, flash memory, ROM, EPROM, EEPROM, registers, hard disk, a removable disk, a CD-ROM, or any other form of storage medium known in the art. Memory 720 can include computer program code. As one of ordinary skill in the art would readily appreciate, apparatus 700 can include any number of processors in alternative embodiments. Likewise, apparatus 700 can include any number of memories in alternative embodiments.

Apparatus 700 can also include a transceiver 730, which is configured to transmit and receive a message, and which is connected to processor 710. Apparatus 700 can also include antennas 740 and 750, where each antenna is configured to assist transceiver 730 in the transmitting and receiving of a message. While the illustrated embodiment in FIG. 7 depicts two antennas, one of ordinary skill in the art would readily appreciate that apparatus 700 can include any number of antennas in alternative embodiments. In an alternative embodiment, apparatus 700 can include a single antenna. In another alternative embodiment, apparatus 700 can include a connection to the Internet, and the connection to the Internet can be used by apparatus 700 to transmit and receive messages.

In an embodiment of the invention, processor 710 and memory 720 can cause apparatus 700 to receive a first message indicating that a new access point has been activated in a first band. Processor 710 and memory 720 can also cause apparatus 700 to determine whether one or more access points are operating, or are capable of operating, in the first band. Processor 710 and memory 720 can also cause apparatus 700 to transmit a second message to the one or more access points, indicating that a reassignment of cell IDs has been triggered in the first band.

According to an embodiment of the invention, a database can be stored at memory 720. The database can include a list of one or more access points that are operating, or are capable of operating, in the first band. According to the embodiment, processor 710 and memory 720 can also cause apparatus 700 to search the database and identify the one or more access points operating, or capable of operating, in the first band. According to an embodiment of the invention, the apparatus can include a support node.

According to an embodiment of the invention, multi-band operation of an access point can be enabled without conflicting cell IDs in each band. Furthermore, multi-band operation of an access point can be enabled while avoiding an assignment of cell IDs across multiple bands. In addition, according to an embodiment, an access point does not have to be present in each band at certain time intervals to check for cell ID conflicts. For example, an access point might use a licensed band with a lower bandwidth only as a fallback solution if the licensed exempt band that can operate with a much higher bandwidth fails. In such a case, a regular operation in the licensed band would be highly inefficient if the access point was required to stop operation on the licensed exempt band, and hop to the licensed band to check for cell ID conflicts. Finally, embodiments of the invention can provide for an immediate initiation of a cell reassignment procedure when a new access point starts to operate in a band.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1-30. (canceled)

31. A method, comprising:
receiving, at an access point, a first message indicating that a reassignment of cell identities has been triggered in a first band; and
transmitting, at the access point, a second message indicating whether the access point will participate in the reassignment.

32. The method of claim 31, wherein the receiving the first message further comprises receiving the first message from a support node.

33. The method of claim 32, further comprising transmitting a third message to the support node, wherein the third message notifies the support node that the access point is interested in receiving further messages about cell identity reassignments in any bands where the access point was previously operating, or is configured to operate in, when the access point changes bands.

34. The method of claim 31, further comprising transmitting a fourth message, at the access point, indicating that the access point has started, or intends, to operate in a first band.

35. The method of claim 31, wherein the receiving the first message comprises receiving the first message from another access point over a common interface.

36. The method of claim 31, further comprising transmitting a third message to other access points in a same neighborhood as the access point, wherein the third message notifies the other access points that the access point is interested in receiving further messages about cell identity reassignments in any bands where the access point was previously operating, when the access point changes bands.

37. The method of claim 31, further comprising transmitting a fourth message, at the access point, indicating that the access point has started, or intends, to operate in a first band.

38. The method of claim 31, further comprising receiving a fifth message, at the access point, from another access point indicating that the another access point has started, or intends, to operate in a first band.

39. The method of claim 38, wherein the fifth message comprises a cell identity of the another access point, location information of the another access point, and band information.

40. The method of claim 31, wherein the second message further indicates whether the access point is interested in receiving future messages.

41. The method of claim 31, wherein the first message comprises at least one of a band information and a cell identity of an access point that triggered the reassignment of cell identities.

42. An apparatus, comprising:
a processor; and
a memory comprising computer program code,
the memory and the computer program code configured to, with the processor, cause the apparatus to
receive a first message indicating that a reassignment of cell identities has been triggered in a first band, and
transmit a second message indicating whether the apparatus will participate in the reassignment.

43. The apparatus of claim 42, wherein the memory and the computer program code are further configured to, with the processor, cause the apparatus to receive the first message from a support node.

44. The apparatus of claim 43, wherein the memory and the computer program code are further configured to, with the processor, cause the apparatus to transmit a third message to the support node, wherein the third message notifies the support node that the apparatus is interested in receiving further messages about cell identity reassignments in any bands where the apparatus was previously operating, when the access point changes bands.

45. The apparatus of claim 42, wherein the memory and the computer program code are further configured to, with the processor, cause the apparatus to transmit a fourth message, indicating that the apparatus has started, or intends, to operate in a first band.

46. The apparatus of claim 42, wherein the memory and the computer program code are further configured to, with the processor, cause the apparatus to receive the first message from an access point over a common interface.

47. The apparatus of claim 42, wherein the memory and the computer program code are further configured to, with the processor, cause the apparatus to transmit a third message to other access points in a same neighborhood as the apparatus, wherein the third message notifies the other access points that the apparatus is interested in receiving further messages about cell identity reassignments in any bands where the apparatus was previously operating, when the apparatus changes bands.

48. The apparatus of claim 42, wherein the memory and the computer program code are further configured to, with the processor, cause the apparatus to transmit a fourth message, indicating that the apparatus has started, or intends, to operate in a first band.

49. The apparatus of claim 42, wherein the memory and the computer program code are further configured to, with the processor, cause the apparatus to receive a fifth message, from another apparatus indicating that the another apparatus has started, or intends, to operate in a first band.

50. A method, comprising:
receiving a first message, at a support node, indicating that a new access point has been activated in a first band;
determining, at the support node, whether one or more access points are operating, or are configured to operate, in the first band; and
transmitting a second message, at the support node, to the one or more access points, indicating that a reassignment of cell identities has been triggered in the first band.
